(19) United States
(12) Patent Application Publication
(10) Pub. No.: US 2009/0076869 A1
(43) Pub. Date: Mar. 19, 2009

(54) Methods and Systems for Price Block Interruption

(76) Inventors: David Isaac Tazartes, New York, NY (US); Yukun Gou, Huntingdon Valley, PA (US); Keith Stuart Groves, London (GB); Jun Chen, Jersey City, NJ (US)

Correspondence Address: LEHMAN BROTHERS INC.;C/O MORGAN, LEWIS & BOCKIUS, LLP, 1111 PENNSYLVANIA AVE. N.W., WASHINGTON, DC, 20004, US

(21) Appl. No.: 12/189,602

(22) Filed: Aug. 11, 2008

Related U.S. Application Data
(60) Provisional application No. 60/954,923, filed on Aug. 9, 2007.

(51) Int. Cl. G06Q 40/00; G06F 9/44

(52) U.S. Cl. 705/7; 705/37

(57) ABSTRACT

In at least one aspect, the invention comprises a computer-implemented method comprising: (a) electronically receiving a price request; (b) processing in a pipeline price information corresponding to said price request by applying a sequence of configurable rules to said price information; (c) temporarily withdrawing said price information from said pipeline while at least one of said configurable rules being applied is waiting for additional information; (d) inserting said price information into said pipeline after said additional information is received by said at least one of said configurable rules; (e) calculating a price based on said processed price information; and (f) electronically transmitting said price in response to said price request. Other aspects of the invention comprise related software and system implementations.

### CROSS REFERENCE TO RELATED APPLICATIONS

This application claims priority to U.S. Provisional Patent Application No. 60/954,923, filed Aug. 9, 2007. The entire contents of that provisional application are incorporated herein by reference.

### INTRODUCTION

Banks and other entities offer their customers the opportunities to trade in currencies. Currency trading is also known as foreign exchange, ForEx, or FX. Typically, the bank displays to a customer a list of currencies from which a customer selects a pair, or the bank may display a list of currency pairs. In any event, with each currency pair the bank associates prices.

Generally, if a customer is buying, an exchange rate (usually given as base currency/quote currency) specifies how much the customer must pay in the quote currency to obtain one unit of the base currency. If the customer is selling, the exchange rate specifies how much the customer would get in the quote currency when selling one unit of the base currency.

A currency exchange rate is typically given as a pair of prices: a bid price and an ask price. The ask price applies when a customer is buying a currency pair, and represents what has to be paid in the quote currency to obtain one unit of the base currency. The bid price applies when a customer is selling, and represents what will be obtained in the quote currency when selling one unit of the base currency. The bid price is always lower than the ask price. The difference between the ask price and the bid price is known as the spread.

A “price” will include not just pricing information such as bid and ask, but also flags indicating whether the price is valid/dealable or invalid/indicative-only (possibly in multiple aspects, such as bid vs. ask), and the reason or reasons why the price is invalid, and potentially other information useful to the customer or other users.

After getting a price request for a currency pair from a customer, banking systems may take many steps before sending prices back to the customer. Such steps may include calculating the base price, checking customer credit, asking other systems or individuals to make some decisions, etc. Since banks usually provide many foreign exchange prices to many customers, there is a need for a system and method that can handle a large number of price requests and process those requests very quickly.

In one aspect, the invention comprises a computer-implemented method comprising: (a) electronically receiving a price request; (b) processing in a pipeline price information corresponding to said price request by applying a sequence of configurable rules to said price information; (c) temporarily withdrawing said price information from said pipeline while at least one of said configurable rules being applied is waiting for additional information; (d) inserting said price information into said pipeline after said additional information is received by said at least one of said configurable rules; (e) calculating a price based on said processed price information; and (f) electronically transmitting said price in response to said price request.

In various embodiments: (1) wherein said sequence of configurable rules is applied only upon occurrence of specified events; (2) said sequence of configurable rules is applied based on recent market data; (3) said sequence of configurable rules is applied in the same linear order each time a price request is received; (4) said price information is temporarily withdrawn from the pipeline by a price interruption block; (5) said price interruption block is a rule block that causes rules to be evaluated in a sequence; (6) said price interruption block is a rule block that asks each rule being applied if the rule is waiting for additional information from an external source; (7) said at least one of said configurable rules waiting for additional information sends an event to the price interruption block when the at least one rule receives said additional information; (8) said price request is for a currency price; (9) said price request is for a security price; (10) said price request is for a swap price; and/or (11) said price request is for a derivative price.

In another aspect, the invention comprises a computer-implemented method comprising: (a) electronically receiving a request for data; (b) processing in a pipeline information corresponding to said data request by applying a sequence of configurable rules to said information; (c) temporarily withdrawing said information from said pipeline while at least one of said configurable rules being applied is waiting for additional information; (d) inserting said information into said pipeline after said additional information is received by said at least one of said configurable rules; (e) deriving said data based on said processed information; and (f) electronically transmitting said derived data in response to said data request.

Other aspects of the invention comprise software and system implementations related to the above methods, as described below and delimited by the appended claims.

### BRIEF DESCRIPTION OF THE DRAWINGS

FIG. 1 depicts steps and components of a first exemplary embodiment.

FIG. 2 depicts steps and components of a second exemplary embodiment.

FIG. 3 depicts a computer based system for processing data according to an embodiment of the invention.

FIG. 4 depicts overall functionality of an exemplary XPS system.

FIG. 5 is an architecture diagram of an exemplary XPS embodiment.

FIG. 6 depicts subscription flow of an exemplary embodiment.

FIG. 7 depicts exemplary steps for a quote response.

FIG. 8 depicts exemplary price event flow.

FIG. 9 depicts exemplary validation event flow.

FIG. 10 depicts exemplary Quote Manager Data Structure.

FIG. 11 depicts exemplary Quote Manager Flow.

FIG. 12 depicts exemplary Control Panel/Registrar flow.

FIG. 13 depicts exemplary Validation Server steps.

FIG. 14 depicts an exemplary extension diagram for XPS.

FIG. 15 depicts an exemplary price decoder interface class diagram.

FIG. 16 depicts an exemplary full price interface class diagram.

FIG. 17 depicts an exemplary tagging restrictions interface class diagram.

FIG. 18 depicts an exemplary PriceListener and PriceListenerTracker class diagram.

FIG. 19 depicts an exemplary Publisher class diagram.

FIG. 20 depicts an exemplary Formatting and Validator class diagram.

FIG. 21 depicts an exemplary Publisher MessageValidator class diagram.

FIG. 22 depicts an exemplary Validator class diagram.

FIG. 23 depicts an exemplary SubscriptionPolicy class diagram.

### DETAILED DESCRIPTION

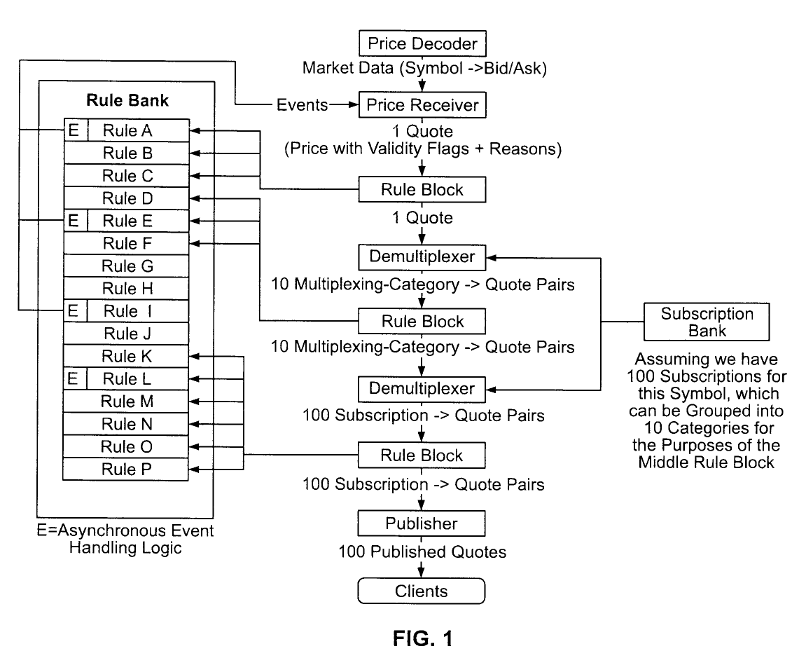

An embodiment of the present invention accomplishes one or more of the above goals by applying “rules” in sequence. As the term is used herein, a “rule” is a piece of logic that handles one or more aspects of validation or pricing. Initially, after a price request is received, one or more rules validate the request itself (for instance, check that it's below the customer's maximum request size). Then, that request is added to a bank of active subscriptions. Upon initial subscription, a change in underlying market data, or any other designated event (generated or parsed by any of the rules, even if not part of the flow), a set of rules will be traversed in sequence. See FIG. 1. These rules validate current conditions in relation to the subscription (for instance, verifying that a currency pair has not been disabled for trading by a trader), validate pricing constraints (for instance, that the source market data's spread is not too wide, which could indicate invalid market data), and change the price (for instance, adding a spread which is specific to a customer). Some rules can be performed on the base price itself regardless of subscription; others require information in the subscription (such as customer-specific settings) to perform their task. Some complex calculations can be shared among a group of subscriptions, such that subscriptions with some of the same attributes can share logic, thus improving performance. So, the rules are divided into several stages of successive de-multiplexing (and sequenced accordingly). See FIG. 1.

In the exemplary embodiment depicted in FIG. 1, the demultiplexer is a special rule block that clones one quote to multiple quotes. For example, the first multiplexer clones the original price pair into multiple quotes based on certain attributes (e.g. tier) of clients. Then the following rule block will modify each quote just created.

Note that the above does not require that the described system only handle simple bid/ask prices. It also may handle prices with greater complexity. The price object itself can be of arbitrary complexity and can be modified at each step according to the rules defined in the system. Indeed, a “price” object need not even refer to a price, but simply a collection of information to be sent to multiple subscribers when a single event occurs, with different information sent to each subscriber according to the subscription settings.

The system is configurable in the sense that the rules to be executed, and their order, is specified in configurations, as well as the configurations for individual rules. The logic itself is implemented in plug-in blocks of code.

In contrast to standard rules engines, which listen for state changes and test all mapped conditions whenever any state changes, an embodiment of the invention starts its sequence of rules only upon occurrence of very specific conditions (change in market data, or other defined event), starts them with the same data (the most recent market data) and applies them all in the same linear order every time. The rules are applied as fast as possible, such that prices can be published very quickly after market data changes. All prices are thus processed sequentially.

However, sequential processing has certain potential disadvantages. Previous sequential processing systems waited for other systems or individuals to make decisions or perform calculations. This process could take far too much time—several seconds, or even minutes. Although this delay doesn't use any processing power, it wastes banks' resources and reduces their ability to process a large number of price requests.

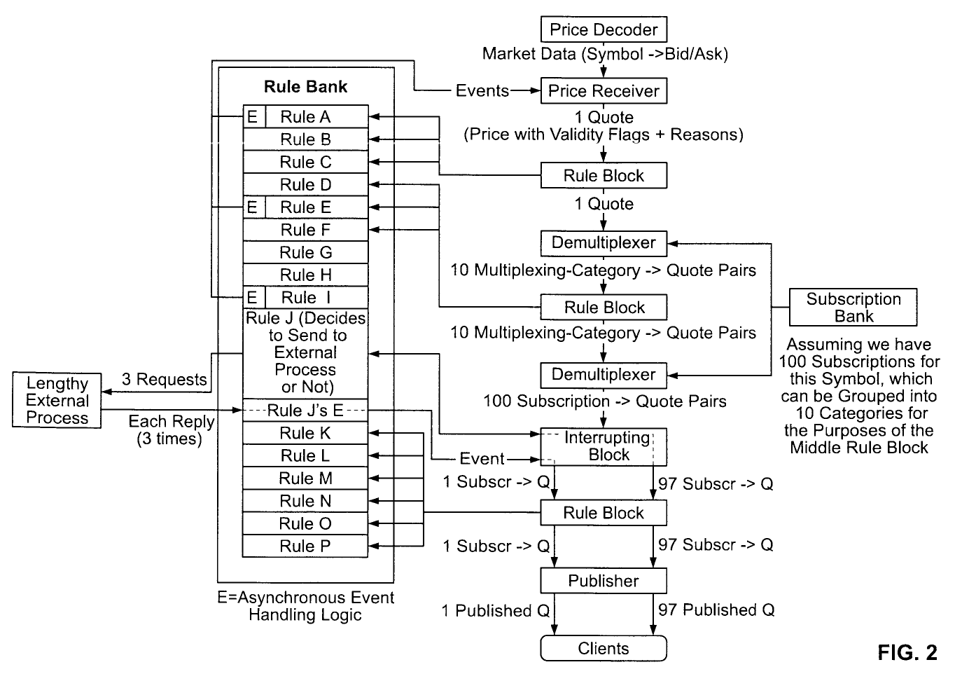

The Price-Interruption Block used in an embodiment solves this problem as follows:
1. A “block” is a piece of logic in an embodiment that causes rules to be evaluated in sequence. Each block references several rules in order; when the price passes through the block, the rules are executed. There are different types of rule blocks; the standard rule block simply executes the rules and accumulates any reasons for invalidity of a price.
2. The Price Interruption Block also executes rules in sequence just as the standard block does; but for each specific price being generated, it also asks each rule applied if the rule is waiting for another system or individuals to proceed. If so, it will remove the specific price from the rule pipeline; otherwise it will continue as usual. See FIG. 2.
3. When the rule gets a reply, it modifies the original price then fires an event to the Price-Interruption Block, which will then put the price back in the pipeline to pass through the rest of the rules. How this is achieved:
1. For these time consuming steps, instead of waiting for replies from other systems or individuals, the system starts processing a new price request immediately. The normal pricing process is interrupted. This saves system resources and improves performance.
2. The system continues the rest of the steps of a price request once other systems or individuals reply to the request. This keeps the normal pricing process unaffected.
3. Where to interrupt the normal pricing process is determined by configurable rules. The rules can be configured in first order blocks to interrupt the pricing for all price requests for a given currency pair, in second order blocks to interrupt the pricing process for a group of price requests, or in third order blocks to interrupt for individual price requests only.
4. In an embodiment, the one or more conditions for determining whether to interrupt the pricing process can be dynamically changed. For example, a rule can be written to ask traders to determine prices for currency pair XXX/YYY. All price requests for XXX/YYY will be forwarded to traders and the normal pricing process will be interrupted. The rule can be dynamically changed—for example, it can receive a message to change XXX/YYY to YYY/ZZZ. The pricing process will then be interrupted for price requests for YYY/ZZZ, not XXX/YYY.

Previously, systems wasted time waiting for replies at certain steps. This reduced systems' abilities to process a large number of customer price requests. With this new method, systems can process more price requests and keep the pricing process flowing.

Those skilled in the art will recognize that the present invention is equally applicable in the context of other streaming systems. Any and all products that have time consuming processes would benefit from the present invention. For example, and not intending to be limiting, other systems that would benefit from the present invention include the following: U.S. Treasuries, Credit Default Swap Indices (CDX), Interest Rate Swaps, other bonds (government, agency, or corporate), and equities.

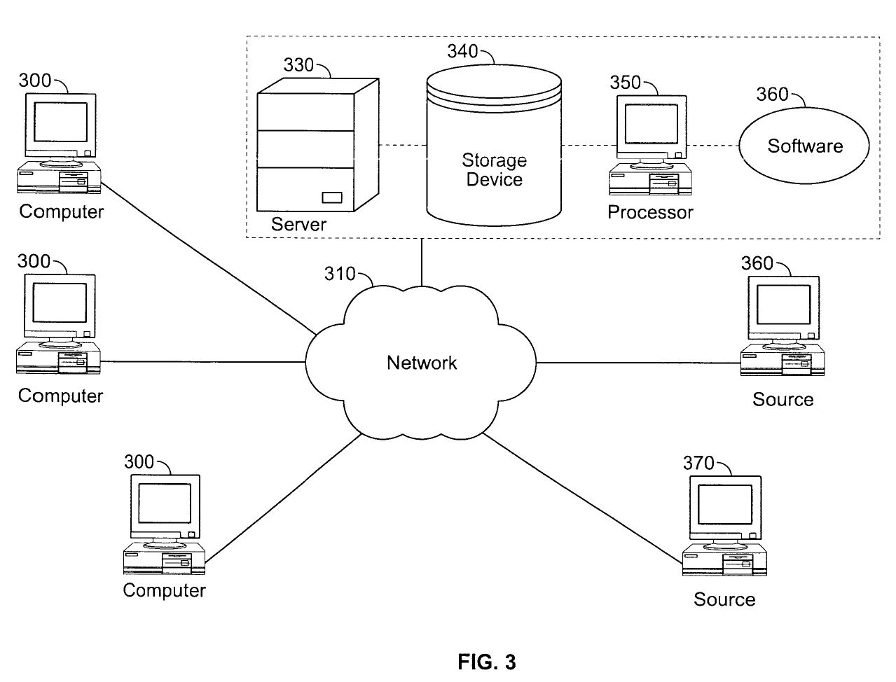

Embodiments of the present invention comprise computer components and computer-implemented steps that will be apparent to those skilled in the art. For example, calculations and communications can be performed electronically. An exemplary system is depicted in FIG. 3. As shown, computers 300 communicate via network 310 with a central server 330. A plurality of sources of data 360, 370 relating to, for example, trading volume data, also communicate via network 310 with a central server 330, processor 350, and/or other component to calculate and transmit, for example, volume forecast data. The server 330 may be coupled to one or more storage devices 340, one or more processors 350, and software 360.

One exemplary implementation of a computer system and software implementation of the invention is described below, in the context of a Cross Product Streaming Service. As those skilled in the art will understand, the invention claimed herein is not limited to the specific details described below, but is limited only by the language of the appended claims.

Cross Product Streaming Service Exemplary Embodiment

A market maker needs to provide quotes of securities to its clients, either individual traders or institutional firms. A streaming service is a service which provides continuous quotes to clients.

A Cross Product Streaming Service (XPS) is a framework for streaming services of various products such as FX, GOV, CREDIT, CORP and SWAP etc. It provides an extensible, flexible architecture and fundamental implementation to reduce costs to develop streaming services and improve maintainability in the long run.

Use Cases

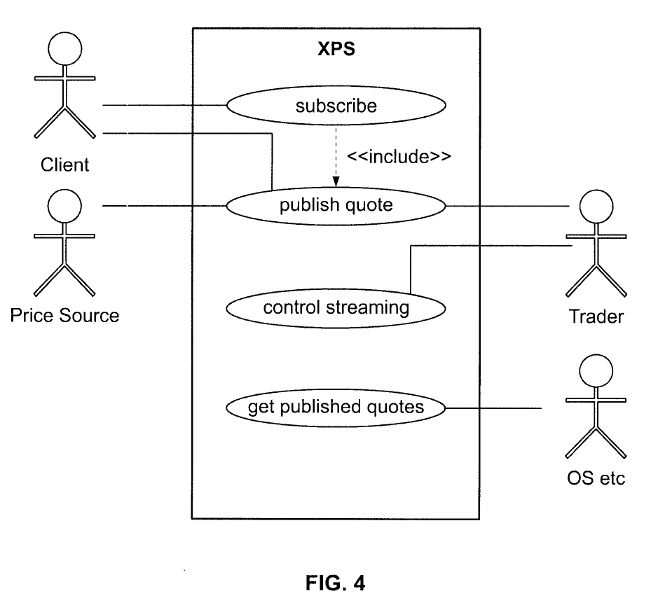

Simply speaking, a streaming service gets quote requests from clients as subscriptions, and gets prices from external sources, then, based on price processing rules, continuously publishes adjusted prices as quotes to clients. See FIG. 4.

Concepts

ECN, Customer and User

These concepts represent the counterparty of a trade. Every customer belongs to an ECN and can have multiple users. Every request should have the ability to identify counterparty information.

Security

Security represents what the system is trading. A security has different attributes depending on the specific product.

Subscription

Subscription is a quote request that establishes a contract between a client and a streaming service server. By this contract, the client will get continuous quotes from the server until one party breaks this contract.

A client initiates a contract by sending a quote request for specific securities to server and server will either reject this request or accept it. If server accepts, it will continue publishing quotes to client whenever there is a new quote available for the securities, until client unsubscribes it or server cancels it.

Price, Price Decoder

Streaming service doesn't typically generate prices for securities. It gets prices from one or multiple external sources. An external price source could be a model based application, or it could be a manual input from a trader.

Since various sources have different formats, a decoder (“Price Decoder”) is needed to decipher the data into an internal format that the streaming service needs.

Price Processing Block

After it has a price, the streaming service needs to decide what to publish and what price adjustment needs to be done for a specific subscription. This is done by price processing blocks. A price processing block may contain a number of price processing rules. The output of this process is a quote.

Quote

Quotes are prices sent to customers, which are calculated according to the individual customer's settings. A quote includes all the components of a price, as well as any errors (reasons why the price isn't dealable).

Quote Manager

Quote manager manages all published quotes. When required, these quotes can be republished to clients again.

### Architecture

Features
Rule based: XPS uses configurable rules in most of its internal components to provide extensibility.
Event driven: XPS is an event driven system, which means flow of an XPS implementation is determined by external messages and trader actions, etc.
Load balance and Fault tolerance: XPS supports both load balance and fault tolerance to provide scalability and reliability.

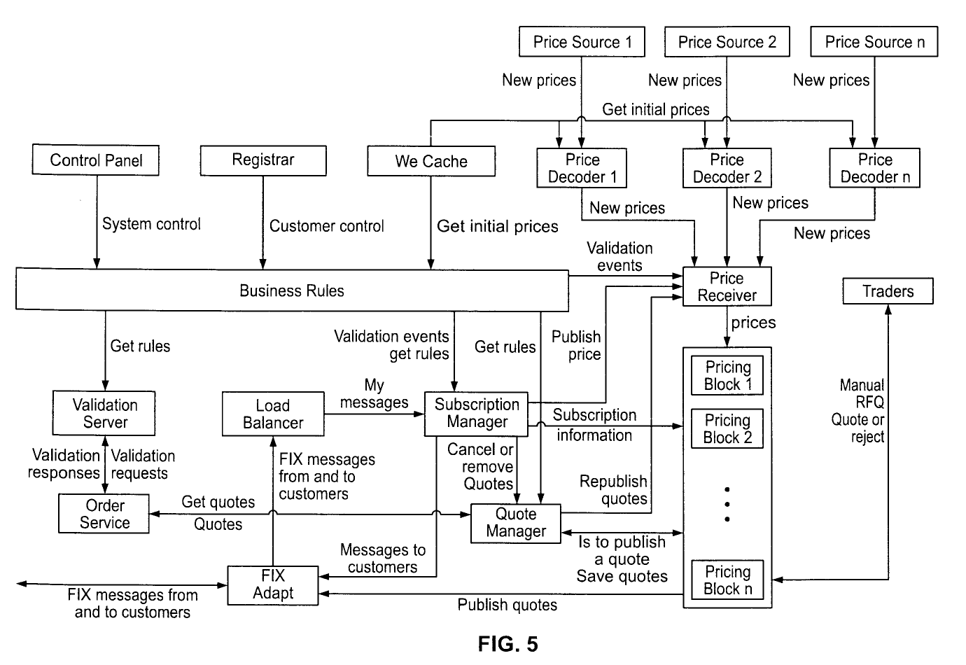

FIG. 5 is an architecture diagram of an exemplary XPS embodiment. Internal components are marked with shadow, and external applications are not shadowed.

Referring to FIG. 5:

Fix Adaptor

Fix Adaptor (“FIX Adapt”) transforms between TIBCO messages and FIX messages (objects).

Load Balancer

Multiple instances are needed to support Load Balancing. When one instance has an issue, another instance can take over the task that instance is running. Load Balancing in Streaming Service is based on Tibcorv FT.

Subscription Manager

Subscription manager manages subscriptions. It converts FIX messages to internal objects, validates subscription information, subscribes/unsubscribes, stores requests and fires a first price.

Price Decoder And Price Receiver

Price Decoder receives prices from price sources (for example, a model), converts to internal objects, caches them and sends to Price Receiver which in turn publishes to listeners.

Pricing Blocks

Pricing blocks consist of an ordered list of blocks. Each price block contains rules which validate a price event and decide whether to publish this price to the next block. Publishing block will consult Quote Manager to decide whether to publish this price to the client.

Quote Manager

Quote Manager maintains published quotes and decides whether a quote should be republished.

Rules

Rules are being used almost everywhere in the streaming service: for example, Price Receiver, Quote Manager and Pricing Blocks. Rules are managed in a Rule Database. All other components will interact with this database when they need rule(s).

Validation Server

Validation Server is used by external applications (for example, order server). It provides validation service by applying rules.

The following are external applications.

Order Service

An order service executes orders from clients. When an order comes from a client, order service needs to check the quote in this order from streaming service.

Control Panel

Control panel control parameters like spread and tradability of securities.

Price Source

Price Sources provide initial prices for securities. A price source could be a model based service or an input from traders.

Web Cache

Web Cache caches prices from price sources which will be used as initial prices by XPS.

Registrar

Registrar manages all customer related information, like tradable securities, accounts, users, tier and spreads etc.

Traders

When an RFQ is out of limit of XPS, it can be rejected or sent to Traders which lets a trader decide whether it should be approved or declined.

Not all external applications are necessary in specific implementation. The figures described below, however, include the above external applications for illustration.

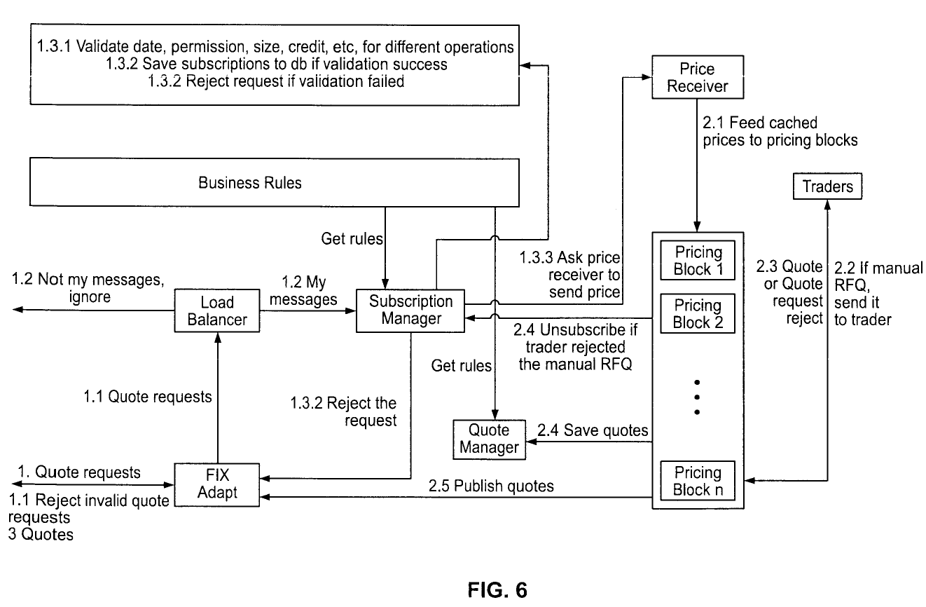

FIG. 6 depicts subscription flow of an exemplary embodiment.

Steps—Quote Request
1 Quote requests from clients. FIX adaptor does simple validations.
1.1 Reject the request if invalid.
1.1.1 Send to load balancer if valid.
1.2 Load balancer will forward the requests to subscription manager if the message is for this instance.
1.3.1 Validate for different operations. Following are some examples:
   Indicative request: date, session, permission and allocation.
   Limit Order: spot, session, permission, account/customer/currency trade size, allocation, spread and credit.
   Market Order: spot, session, permission, allocation, account/customer trade size, spread and credit.
   Quote request: date, session, permission, allocation, account/customer trade size, spread, auto forward quote, uneven swap, maturity.
   RFQ: date, session, permission, allocation, account/customer trade size, spread, credit, throttle, flow limit, auto forward quote, uneven swap, manual pricing EMG.
1.3.2 Save the request to DB if 1.3.1 success.
1.3.2 Reject the request if 1.3.1 failed.
1.3.3 Ask price receiver send price from cache for this request.
2.1 Price receiver feeds prices to pricing blocks for this request.
2.2 Send the request to traders if the request is an RFQ and business rules determined that it is a manual RFQ.
2.3 Trader can quote or reject the manual RFQ.
2.4 If the manual RFQ is rejected, unsubscribe from the system.
2.4 Save quotes.
2.5 Publish quotes.
3 FIX Adaptor sends quotes to clients.

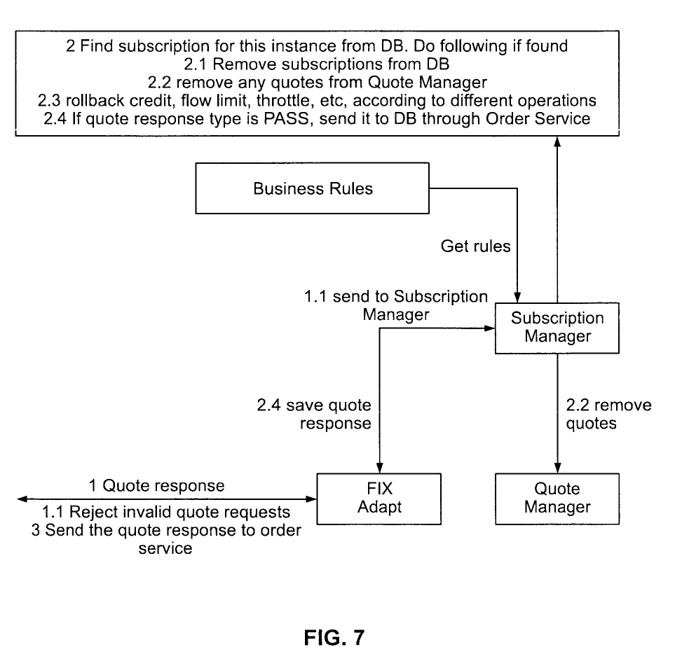

FIG. 7 depicts exemplary steps for a quote response.

Steps—Quote Response
1 Quote responses from clients. FIX adaptor does simple validations.
1.1 Reject the request if invalid.
1.2 Send to Subscription Manager if valid.
2 Find subscriptions for this instance from DB. Do following if found:
2.1 Remove subscription from DB.
2.2 Remove quotes from Quote Manager.
2.3 Rollback credit, flow limit, throttle, etc, according to different operations.
2.4 If the Quote Response type is PASS, save it.
3 FIX Adaptor send the Quote Response to Order Service to save.

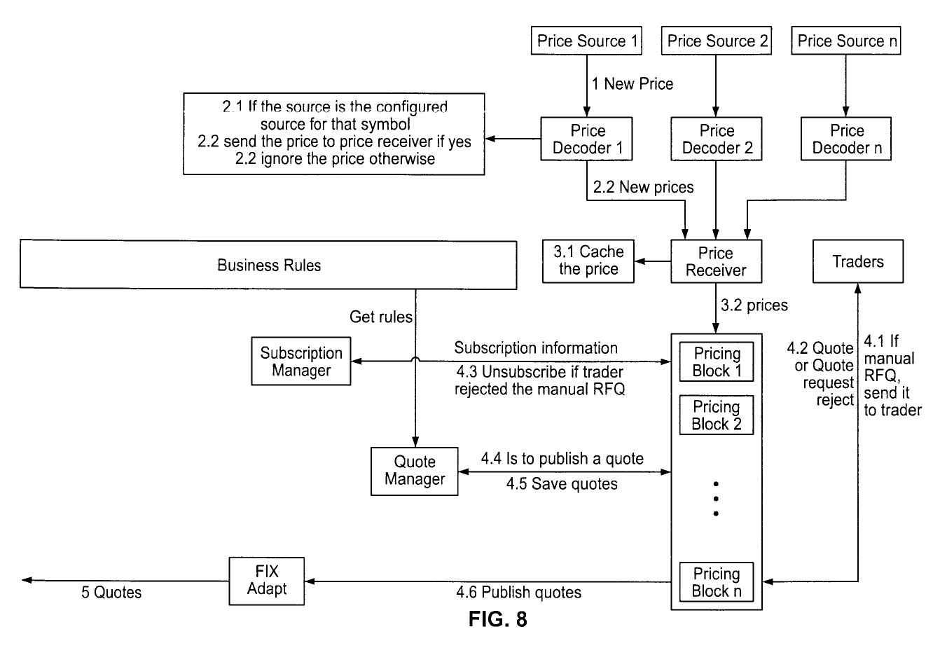

FIG. 8 depicts exemplary price event flow.

Steps
1 A price source published new price for a symbol
2.1 Price decoder check if the source is the configured source for that symbol
2.2 Ignore the price if it's not the correct source
2.3 Send the price to Price Receiver
3.1 Price Receiver caches the price
3.2 Feed the price to pricing blocks
4.1 If an RFQ is a manual RFQ for that symbol, send the RFQ request to traders
4.2 Trader sends a quote or rejects the request
4.3 Unsubscribe the request if trader rejected the RFQ
4.4 Do following if a quote should be published:
4.5 Save the quote
4.6 Publish the quote
5 Send the quote to client

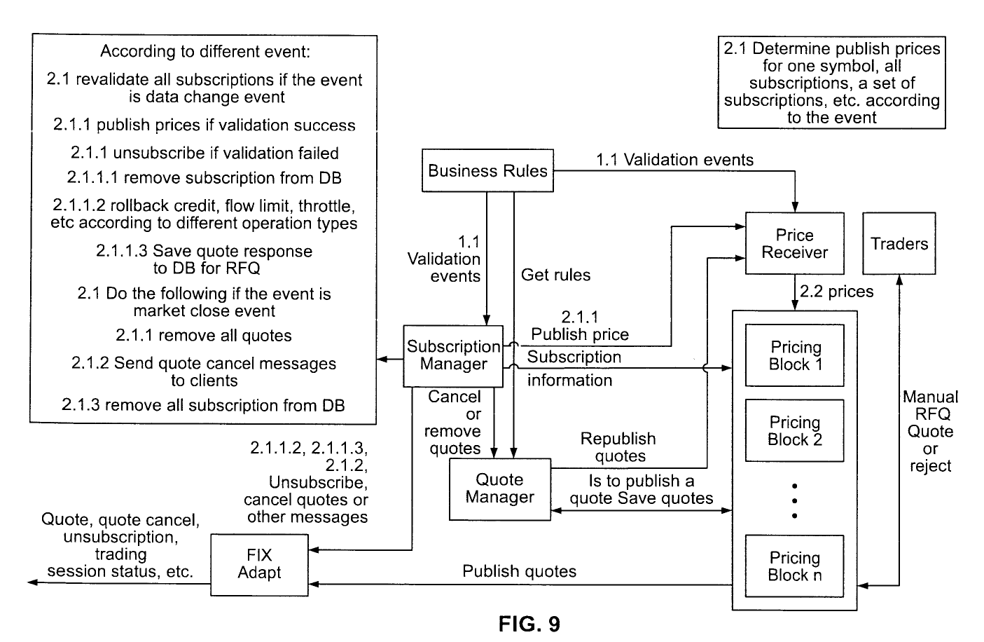

FIG. 9 depicts exemplary validation event flow.

Steps—Subscription Manager
1 A business rule fires a validation event because of data changes, timer events, lost heart beats, etc.
1.1 Subscription Manager catches the event
2.1 Do the following if the event is market close event:
2.1.1 Remove all quotes
2.1.2 Send quote cancel messages to clients
2.1.3 Remove all subscription from DB
2.2 Revalidate all subscriptions if the event is due to data change in DB tables such as customer, ecn, account, currency, etc.
2.3 Do the following if revalidation failed:
2.3.1 Unsubscribe if validation failed
2.3.1.1 Remove subscription from DB
2.3.1.2 Rollback credit, flow limit, throttle, etc according to different operation types
2.3.1.3 Save quote response to DB for RFQ
2.3.1 Publish prices by firing a validation event to Price Receiver if validation success

Steps—Price Receiver
1.1 Price Receiver catches the event.
2.1 Price Receiver determines to publish prices for one symbol, all subscriptions, a set of subscriptions, etc. according to the event.

The same as 3.2 in “New price from a price source” from now on FIG. 2, discussed above, depicts detailed (price and validation) event flow.

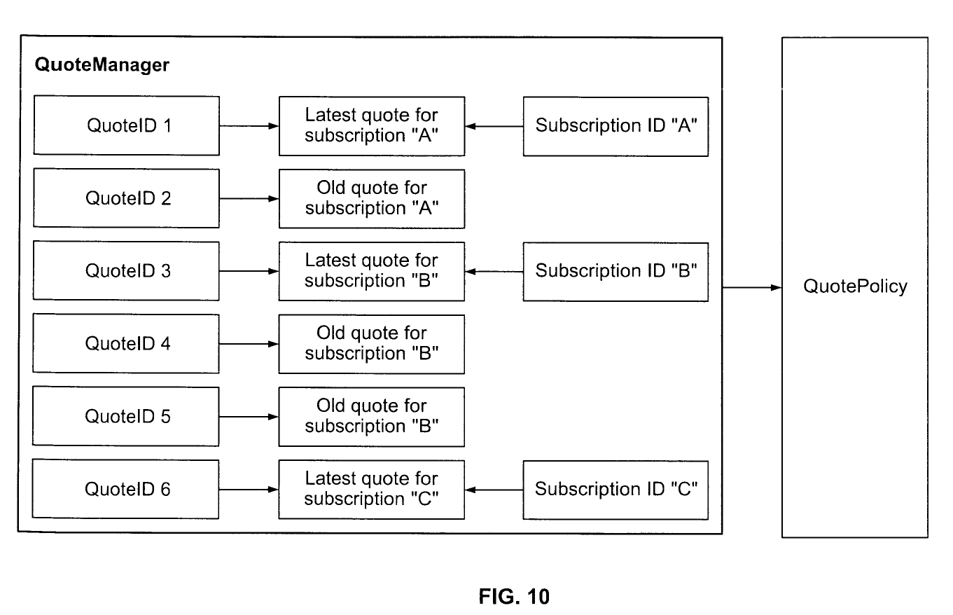

FIG. 10 depicts exemplary Quote Manager Data Structure.

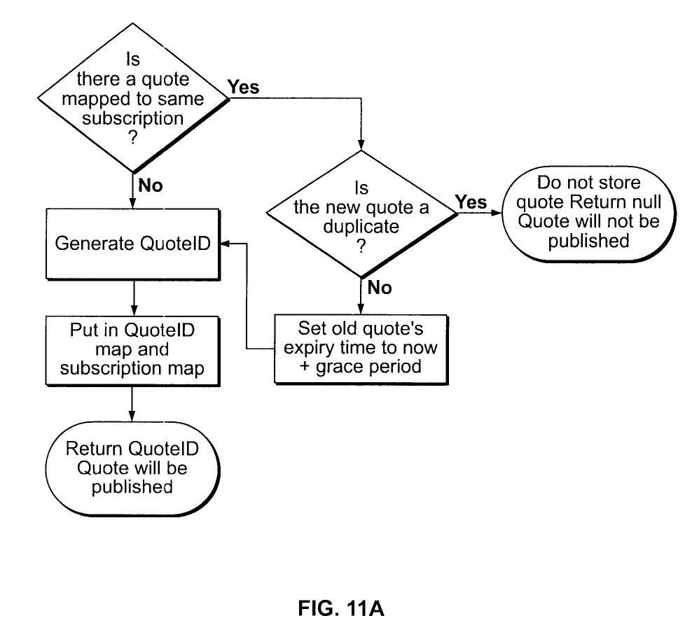

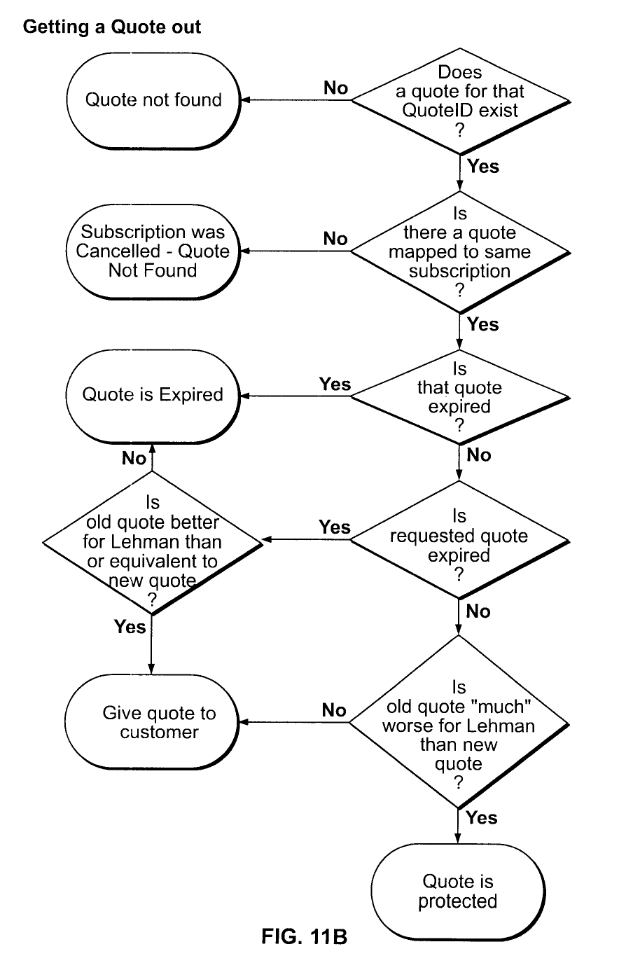

FIG. 11 depicts exemplary Quote Manager Flow.

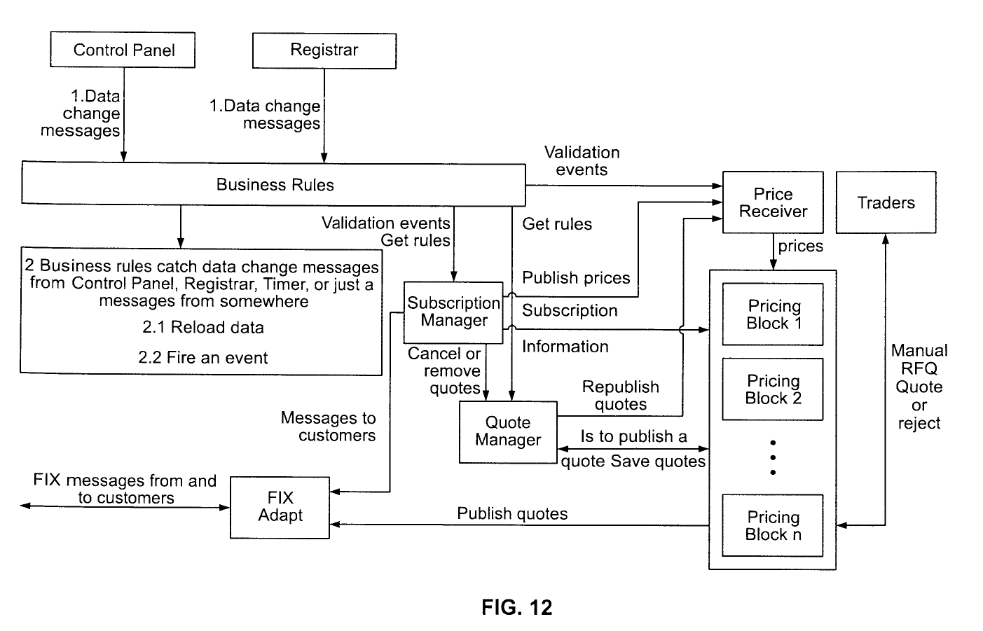

FIG. 12 depicts exemplary Control Panel/Registrar flow.

Steps
1 Trader change data through Control Panel, Administrator change user data through Registrar, Timer fire an event, or somebody sent an update message.
2 Business rules catch the message.
2.1 Reload data
2.2 Fire an event

The same “Validation Event” from now on.

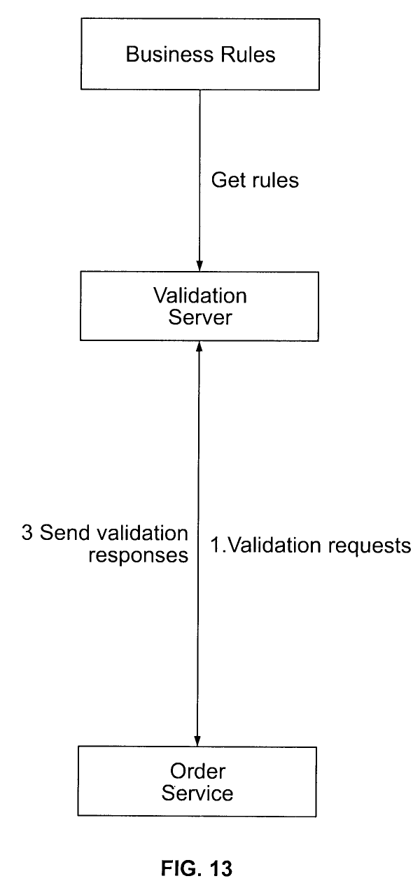

FIG. 13 depicts exemplary Validation Server steps.

Steps
1 Validation server get validation requests with rule names from Order Service
2 Get and run validation rules
3 Send validation results

Core abstractions
EntityInfo
CustomInfo
ECNInfo
SubscriptionInfo

Each product needs to implement its own ECNInfo/ECNLookup. CustomerInfo/CustomerLookup, DateInfo/DateLookup, SecurityInfo and corresponding lookup class.
PriceDecoder
PriceReceiver
PriceListener
   PriceLink
Validator
   Lookup
   PriceChecker
Price
   PriceBall
   PriceClump
   FullPriceClump
Quote
ValidationEvent
UntaggedInfo, MultiplexedInfo, SubscriptionInfo Technology
TradeTone2
Java 1.4
FIX

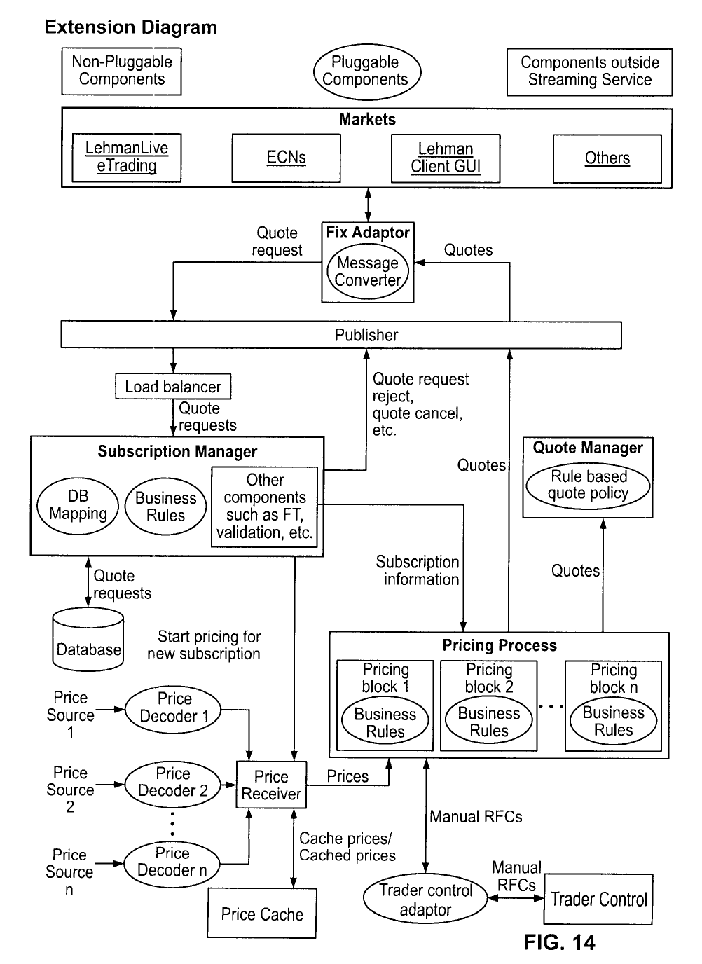

FIG. 14 depicts an exemplary extension diagram for XPS.

Fix Adaptor

Fix Adaptor transforms between TIBCO messages and FIX messages (objects).

One interface that may need extension is FIXMsgRvMsgConverter which translates between TibrvMsg and FIXMsg Object.

Publisher

Publisher is the gateway to streaming service. It decides which server to send a request (FIX message) to and which clients to send a price (FIX message) to. An XPPublisherManager manages and maintains one server (XPPublisherServer) and multiple clients (XPPublisherClients). Server connects to internal XPS components like SubscriptionManager (by SubscriptionFixConnection). “Clients” contains all clients (XPPublisher (implemented by XPPublisherClientFIXClient)). A client could be an actual client, an order service, or a database client, etc.

Load Balancer

Multiple instances are needed to support Load Balancing. So when one instance has an issue, another instance can take over tasks that instance is running.

Load Balancing in Streaming Service is based on Tibco FT and has more granularities. In a streaming service instance, a SubscriptionGroup is an atomic unit for load balance and it can be a backup of the same SubscriptionGroup in another instance. There can be multiple SubscriptionGroups in one instance.

Let's say there are 2 instances, instance A in host H1 and instance B in host H2, and in each instance, there are two SubscriptionGroups S1 and S2. S1 on H1 is a backup of S1 on H2 and S2 on H2 is a backup of S2 on H2.

Subscription Manager

Subscription manager manages subscriptions. It converts FIX messages to internal objects, validates subscription information, subscribes/unsubscribes, stores requests and fires first price.

Subscription Message flow:

TibMessage (-FIXConnectionImpl.onMsg-) FixMsg (-
XPPublisherFIX.onFIXMsg-) (-XPPublisherManager.onFIXMsg-)
(XPPublisherManager.onFIXMsg.>sendServer)
(XPPublisherServerStreaming.sendServer)
(SubscriptionFIXConnection.onFIXMsg)
(SubseriptionMessageHandler.handle)
SubscriptionInfo (SubscriptionManager.subscribe)
(SubscriptionConversions) Map

Following are interfaces that may need extension: SubscriptionInfo, IFormatter, SubscriptionDataHandler, SubscriptionConversions. More details are provided in the Interface section below.

Price Decoder and Price Receiver

Price Decoder receives prices from price sources, converts to PriceClumps, catches them and publishes to listeners.

Follower are interfaces that may need extensions: PriceDecoder, PriceReceiverEventTranslater, PriceCache

Pricing Blocks

Pricing blocks consist of an ordered list of blocks. Each price block has its specific task like validating a price event and deciding if publish this price to next block etc. Publishing block will consult QuoteManager to decide if publish this price to client.

Each price block is a PriceListener which processes PriceBalls (by method on Prices (PriceBall prices)), and also it is a PriceListenerTracker which is used to link all PriceListeners together. Some implementations of PriceListener are
UnusedPriceFilter: filter prices that are not subscribed.
PriceLink: an adapter to execute PriceRuleBlock which run rule(s). It can use multiple threads to run PriceRuleBlock, in this case, PriceBalls are put in a queue and picked up by the threads. Depending on the return of PriceRuleBlock, the PriceBall is passed to next PriceListener.
PriceTagger: split a price for one UntaggedInfo into prices for multi MultiplexedInfo
PriceReDistributor: split a price for one MultiplexedInfo into prices for multi SubscriptionInfo
PricePublisher: generate PriceQuote
QuotePublisher publishes Quote messages

To publish a price to clients, a price has to go through all the blocks.

A PriceBall consists of a securities symbol, restrictions and a map between UntaggedInfo (/MultiplexedInfo/SubscriptionInfo) and FullPriceClump.

TagginigRestrictions is converted from ValidationEvent by PriceReceiverEventTranslator

In various phases of the pricing processing flow, a price may have a different form. When it is in PriceReceiver, the price from PriceDecoder is in the form of PriceClump. When it is converted to a FullPriceClump which is used to construct a PriceBall. In the following blocks the PriceBall will be multiplexed for each MultiplexedInfo and then for each subscription (SubscriptionInfo).

Following are interfaces that may need extensions: UntaggedInfo, MultiplexedInfo, SubscriptionInfo, IFullPrice, MultiLegPrice, PriceQuote, and rule implementations for Validator.

Quote Manager

Quote Manager manages quotes and decides whether a quote should be published.

Key interfaces: QuotePolicy

Rules

Rules are being used almost everywhere in streaming service, for example, PriceReceiver, QuoteManager and Pricing Blocks. Rules are managed in a Rule Database. All other components will interact with this database when they need rule(s).

Following are interfaces that may need extensions: Validator

Interfaces

IFormatter

IFormatter converts a quote request to a SubscriptionInfo object and validates the info. It also generates quotes, quote request rejects, quote cancels, etc.

Base Implementation: AbstractFormatter

Example Implementations: CreditFormatter

SuscriptionInfo

Each quote request for an instrument is represented by a SubscriptionInfo object, which includes all the information for Streaming Service to handle quote request, evaluate business rules and publish quotes.

Base Implementation: SubscriptionInfoBase

The implementation of SubscriptionInfo of each product should derive from SubscriptionInfoBase and implement the product specific requirement.

SubscriptionDataHandler

For each quote request, streaming service validates the requests, populates data, and refreshes SubscriptionInfo when customer information has been changed and prices will be affected. All those preferably are done through this interface.

Base Implementation: SubscriptionDataHandlerBase

SubscriptionConversions

Streaming service converts between SubscriptionInfo and database row so that SubscriptionInfo can be saved to/loaded from DB.

Base Implementation: SubscriptionConversionsBase

Example Implementations: CreditSubscriptionConversions

PriceDecoder

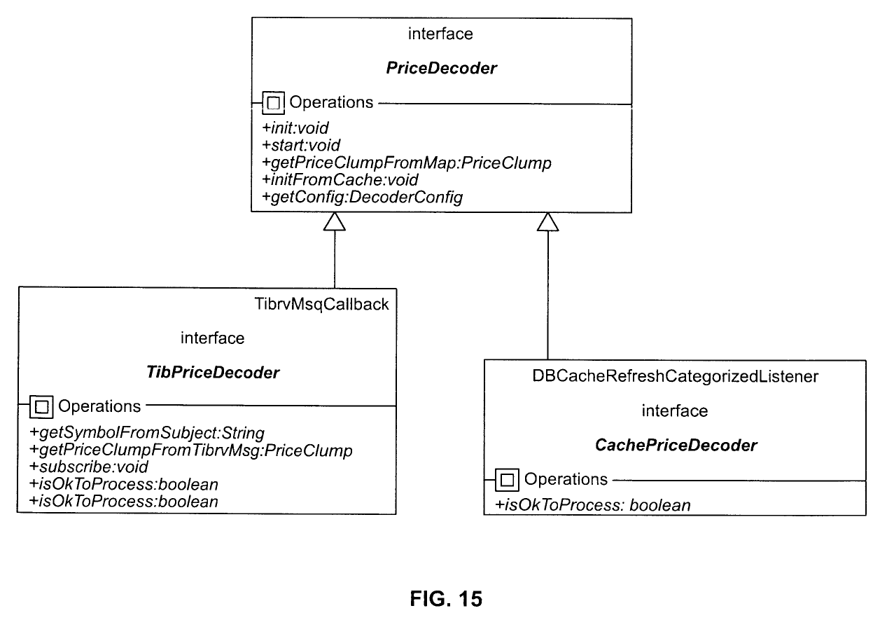

See FIG. 15. Price decoders translate prices from price sources into PriceClump objects. This exemplary implementation defines two kinds of PriceDecoders: tib PriceDecoders, which get prices from tib messages, and cache PriceDecoder, which get prices from the database.

PriceDecoderBase: base implementation of PriceDecoder.

TibPriceDecoder Base: base implementation of TibPriceDecoder.

CachePriceDecoderBase: base implementation of CachePriceDecoder.

A new price decoder needs to implement two methods if the class is derived from base implementation:

public PriceClump getPriceClumpFromTibrvMsg(TibrvMsg m) throws Exception;

public PriceClump getPriceClumpFromMap(Map price) throws Exception:

PriceCache

Steaming service caches all prices from all price sources for later use.

PriceCacheBase: base implementation.

FullPrice

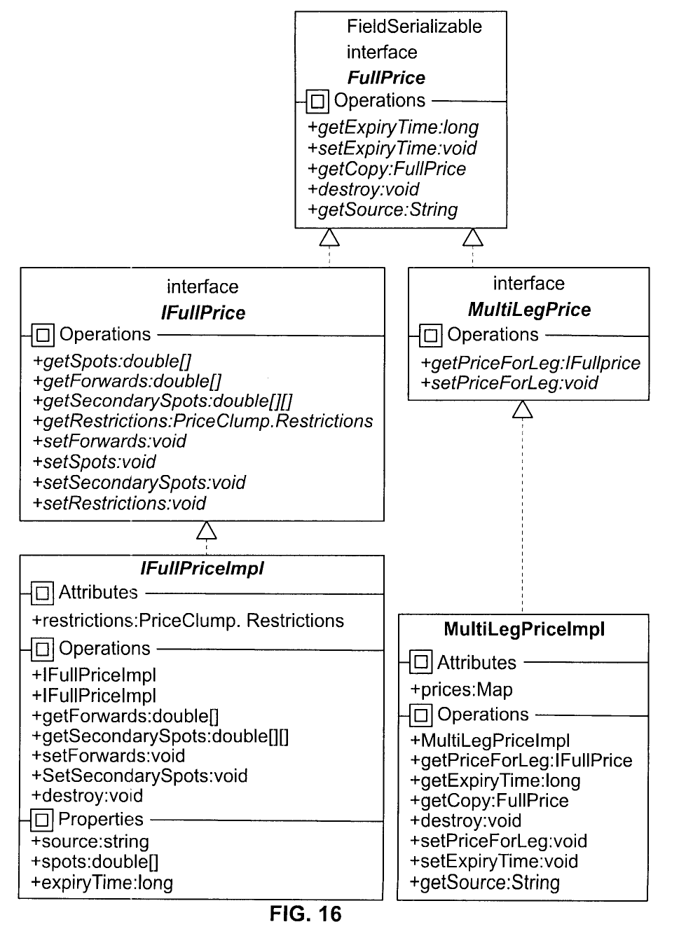

If a quote request is for one instrument, an IFullPrice object will be passed into business rules. If a request is for more than one instrument, such as swap or butterfly, a MultiLegPrice object is passed into business rules. See FIG. 16.

Validator

Validator defines an interface for a rule.

PriceListener, PriceListenerTracker

Refer to Appendix A for class diagram.

PriceReceiverEventTranslator, TaggingRestrictions and TaggingInterpreter

Streaming service is an event driven system. Each event potentially affects some or all prices. For example, repo rate related events won't affect quote requests with cash settle, forward related events won't affect spot quote request, etc.

TaggingRestrictions is the restriction to prices related to an event.

PriceReceiverEventTranslator translates an event to an object of TaggingRestrictions.

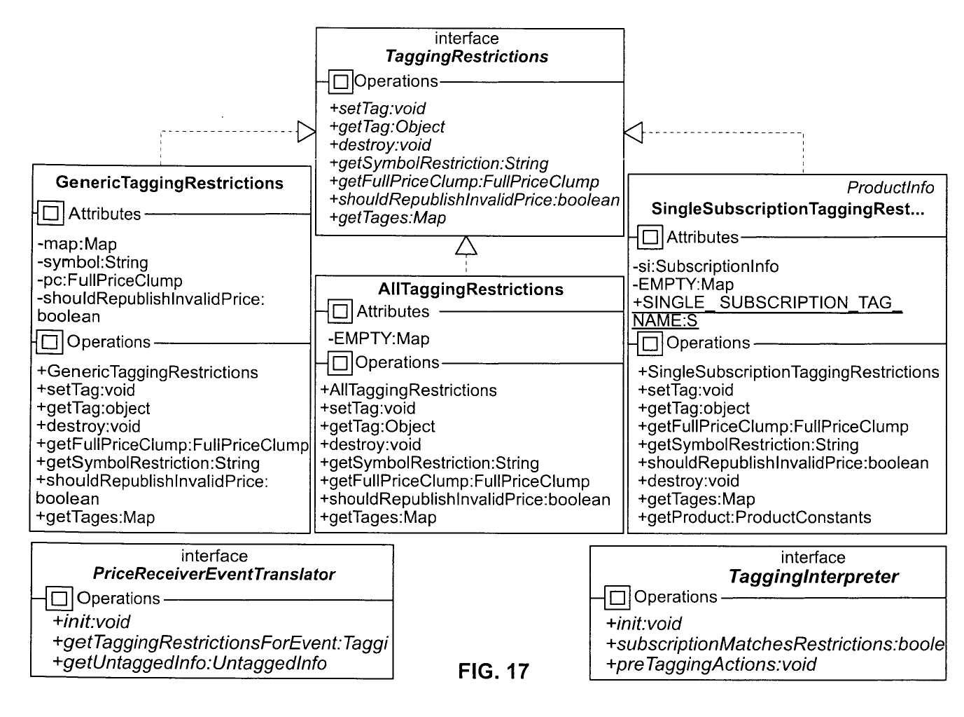

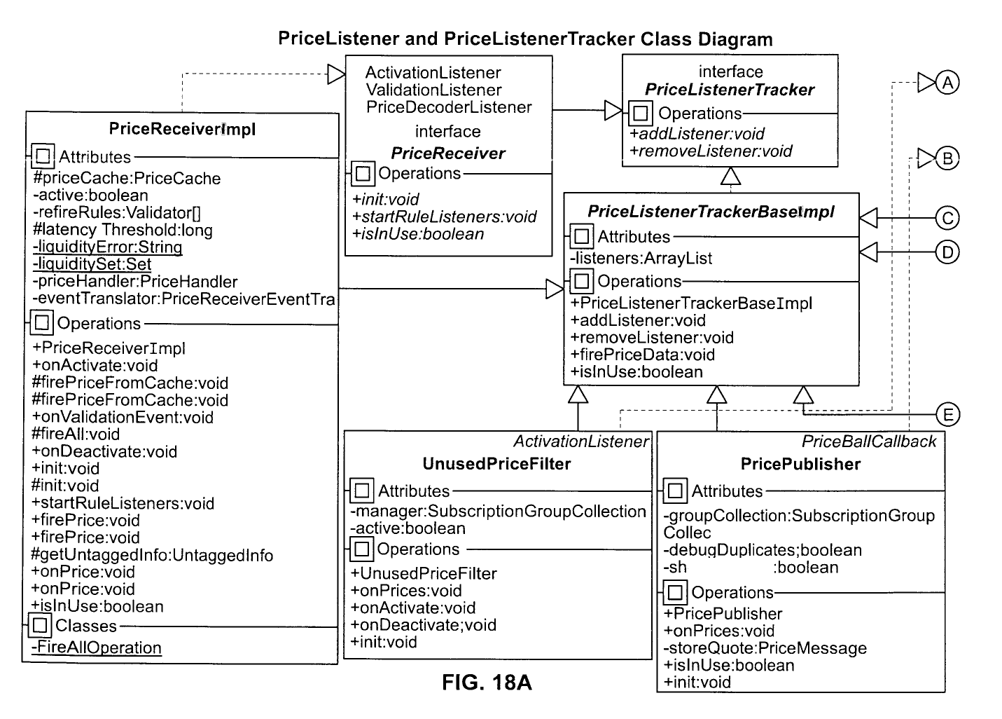

TaggingInterpreter determines if a price with restrictions affect a quote request or not. See FIG. 17.

GenericTaggingRestrictions: generic implementation of TaggingRestrictions.

PriceReceiverEventTranslatorBase: base implementation of PriceReceiverEventTranslator.

TaggingInterpreterBase: base implementation of TaggingInterpreter.

QuotePolicy

QuotePolicy determines whether a new quote should be published, an expired quote should be cleared, two quotes are equivalent, etc.

Base implementation: QuotePolicyBase

### Configuration

XPS is built based on tradetone2 whose configuration can be in various formats: LDAP, Prop files, XML, etc. Here we use LDAP as an example. Other formats have similar tree structure.

blocks

blocks defines a list of pricing blocks. Blocks are initialized and linked in natural order of the block names.

```
LDAP Structure
blocks
    |-- <block1 >
        |-- <plClass>
    |-- <block2>
        |-- <plClass>
        |-- <config1 >
```

Each block defines a p1Class (PriceListener) Class Name. Each p1Class may require different configuration items. For example a PriceLink requires configuration for a PriceRuleBlock which in turn requires configuration for rules.

Some other configurations for a block are listed below:
threads: how many threads are running in the block. Default is 0.
class: class name. Required by some p1Classes
rules: rules that run in this block. Multiple rules are separated by |.
latencyThreshold

Reference

Refer to appendix A for PriceListener diagram.

formatters

formatters defines IFormatters (with message validators) which validate client requests

```
LDAP Structure
formatters
    |-- <product>
        |-- class: name of implementation class
        |-- validators:
            |-- <validators for specific request type A>
            |-- <validators for specific request type B>
                |-- MsgType: message type
                |-- <validator>
                    |-- class and fields.
            |-- <validators for all request types>
```

Under formatters is a list of products. Under each product are the implementation class of IFormatter and validators.

validators: They are two types of message validators. One is used to validate all requests. The other is used to validate specific type of validators. Type is defined in MsgType. Validator implements MessageValidator, an interface which validates message fields in a message

Reference

Interlace IFormatter & MessageValidator, and related classes are defined in com.lehman.fiet.xp.productapi formatting.

Some implementation of MessageValidator are defined in com.lehman.fiet.xp.publisher.validation.

MessageValidator. They are used in IFormatter. Refer to Appendix A for related diagrams.

MessageValidator is not Validator. Validator defines an interface to validate the semantic in a message. They are used in rules.

hostMappings

hostMappings defines hosts that can process requests and related policies which define how the host processes requests.

LDAP Structure
hostMappings
|-- host: policy (+appendix)

One host can have multiple policies (separated by |). One policy maps to one SubscriptionGroup. All SubscriptionGroups compose a SubscriptionGroupCollection.

A SubscriptionGroup is a member of Tibco fault-tolerance group. Since one host can have multiple policies, so an instance can be a member of multiple FT Groups. A SubscriptionGroup is independent of each other. Each member has its own QuoteManager, SubscriptionManager and gets requests from its own fix connection. But all SubscriptionGroups share the same PriceReceiver, rules and configurations for QuoteManager and SubscriptionManager.

Appendix can be * or +. * give the member ability to weigh over regular member of a FT group. While * has the highest weigh over other members and there is only one policy with *.

If it is not defined in hostMappings, a host cannot process requests from clients.

Reference

policies specified in hostMappings are defined in policies.

policies

policies defines policies referred in hostMappings. A policy is used to decide whether a message should be processed in this instance.

```
LDAP Structure
policies
    |--- <policyA>
            |--- class implementation of SubscriptionPolicy.
            |--- <configurationa> Based on the value of class, there
        will be different configurations.
```

Reference

priceReceiver

```
LDAP Structure
priceReceiver
        |--- class: implementation of PriceReceiver
        |--- eventTranslatorClass: name of implementation of
    PriceReceiverEventTranslator which translates ValidationEvent to
    TaggingRestrictions
        |--- priceCache: rule name of priceCache which will be listener
of PriceReceiver designated in class
        |--- refireRules: rules that will have this receiver as listener,
which mean an event from these rules will trigger the process flow.
        |--- symbolLookup: rule that is used to look up symbol. This
rule is used by PriceReceiverEventTranslatorImpl
        |--- latencyThreshold:
        |--- sources
            |--- source: class of IFullPriceFactory which creates
    FullPrice
```

quoteManager

```
LDAP Structure
quoteManager
    |-- cleanupRateMs
    |-- waitingOnQuotesRetries
    |-- waitingOnQuotesRetryTime
    |-- policy
        |-- class: implementation class of QuotePolicy
        |-- republishPadding
```

Reference

rules

rules define all the rules that are used by many parts of streaming services—for example, blocks and pricereceiver. Rules are initialized according to the sequential order defined in LDAP.

```
LDAP Structure
rules
    |-- <rule1>
    |-- <rule2>
        |-- class: implemention class that implements Validator
        |-- init parameters for this class
```

Each rule has a configuration item called class, which is the class name that implements the rule. This class implements interface Validator. Depending on the value of class, additional configuration items maybe required.

Reference

Validator interface is defined in com.lehman.fiet.validation.api.

ValidatorDatabase is used to manage (contain and retrieve) all rules.

subscriptionManager

subscriptionManager defines all the configuration items for Subscription Manager.

```
LDAP Structure
subscriprionManager
    |-- converter
        |-- class: implement class of SubscriptionConversions
    |-- events
        |-- <event>
            |-- class: <eventhandler>
    |-- fixconnection
        |-- dbserver
        |-- ecnLookup
        |-- messageHandlers
        |-- subscription
            |-- clients
            |-- server
    |-- handler
        |-- class: implement class of SubscriptionDataHandler
        |-- rulesByKey:
            |-- <key1>
                |-- validations: rules separated by |, rule refers
            to rule in rules.
    |-- suscriptionCache
```

converter: defines the class (which implements SubscriptionConversions) to convert between SubscriptionInfo and database row. This class will be used by SubscriptionBackEnd.

handler: defines configuration items needed by a SubscriptionDataHandler implementation. A SubscriptionDataHandler processes SubscriptionInfos (validate, fill information, rollback etc) which are converted from FIX Messages which were sent by clients. To validate a SubscriptionInfo, first it extracts a key from the SubscriptionInfo and by the key gets validation rules to validate this SubscriptionInfo.

events: defines configuration items needed by EventHandler implementation. EventHandler is called when there is a ValidationEvent fired by rules. The events occur much less than events in pricing blocks.

fixconnection: defines connections between server and clients (receive and send messages). In streaming service,
dbserver: includes configurations of a XPPublishManager for database, which doesn't have a server.
subscription: includes configurations of a XPPublishManager for clients and server.
messageHandlers: each FIX message type has a SubscriptionMessageHandler associated to process this type of messages. Here it defines overriding handler for messages with specific type.

suscriptionCache: configurations used by SubscriptionBackEnd which saves and retrieves SubscriptionInfo.

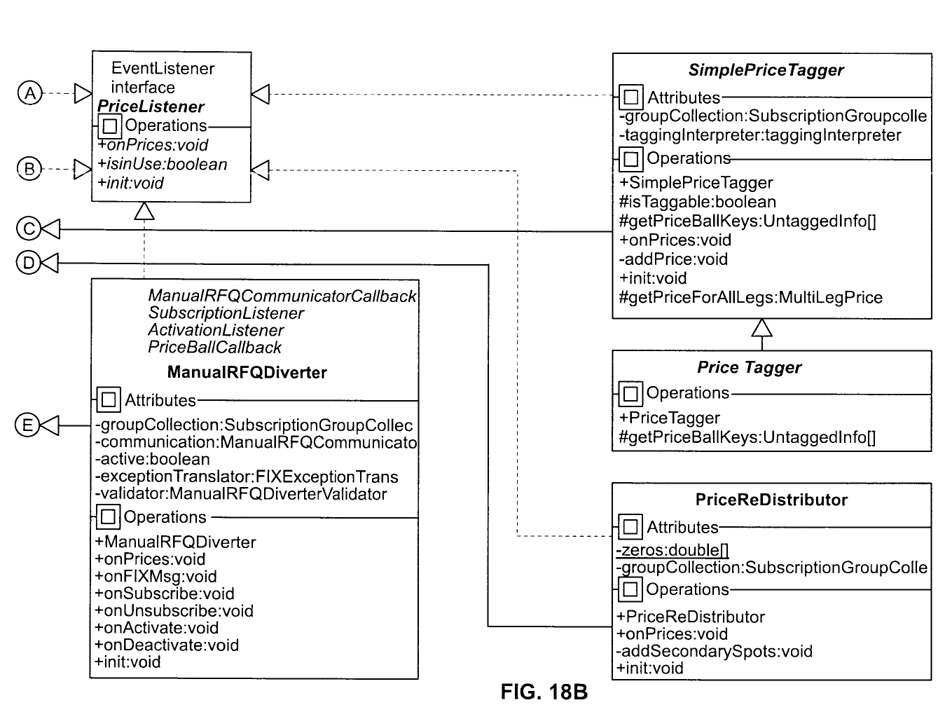

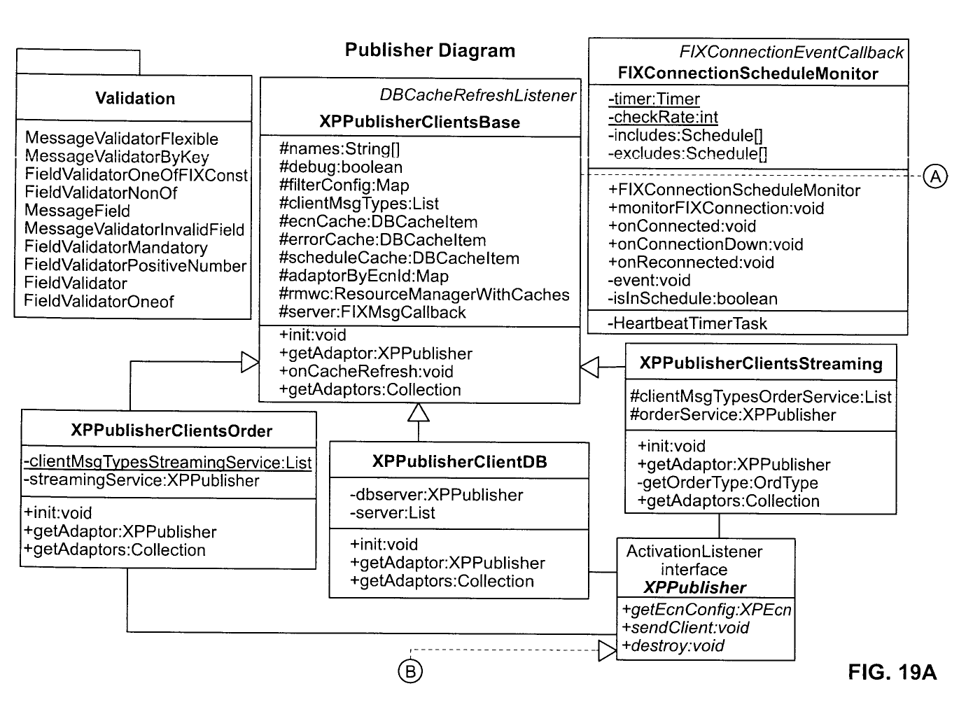

Appendix (FIGS. 18-23)

FIG. 18 depicts an exemplary PriceListener and PriceListenerTracker class diagram.

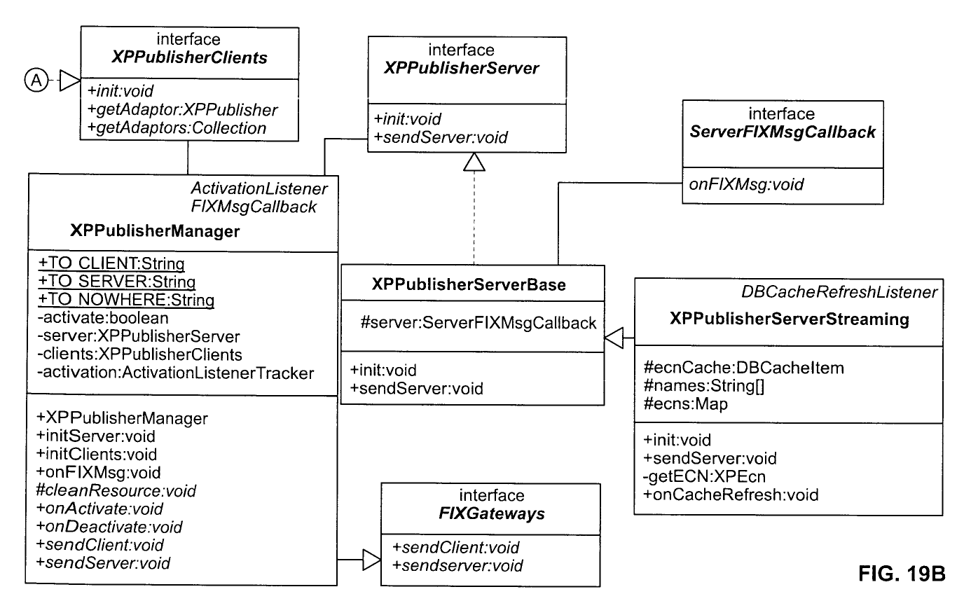

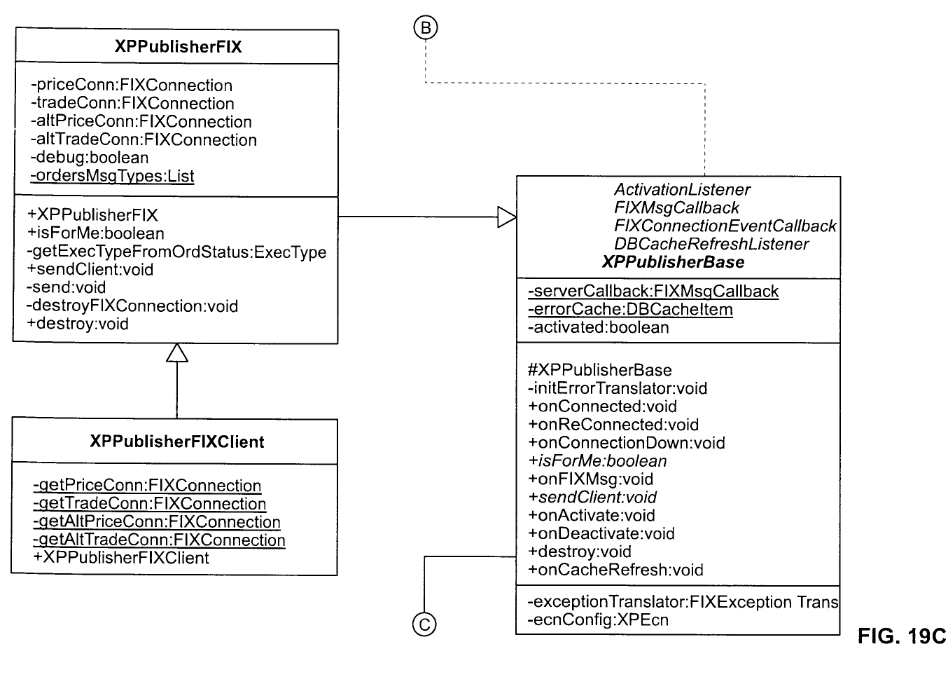

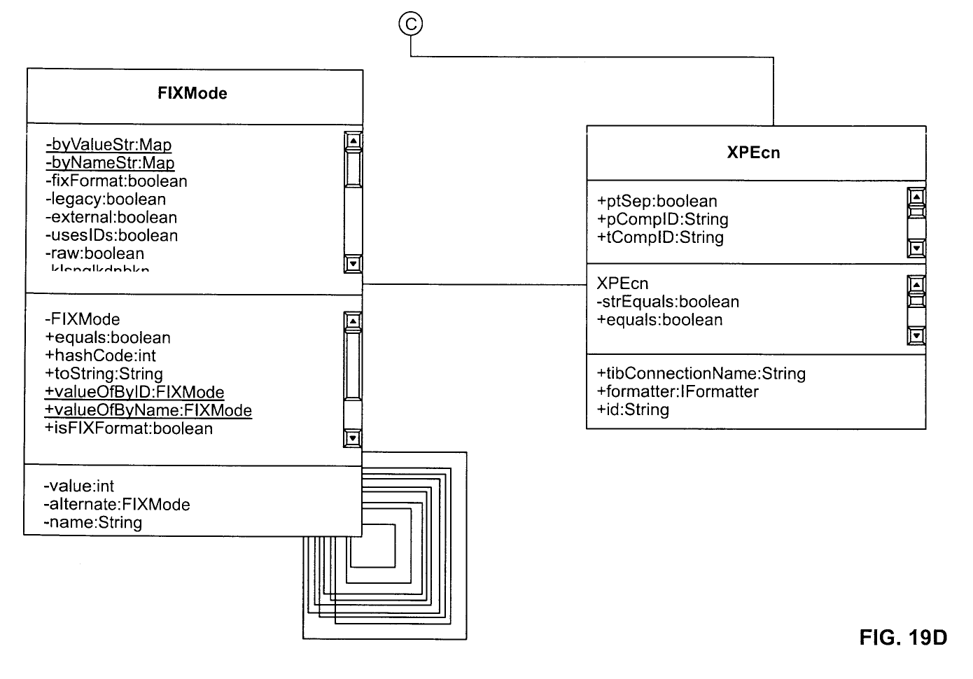

FIG. 19 depicts an exemplary Publisher diagram.

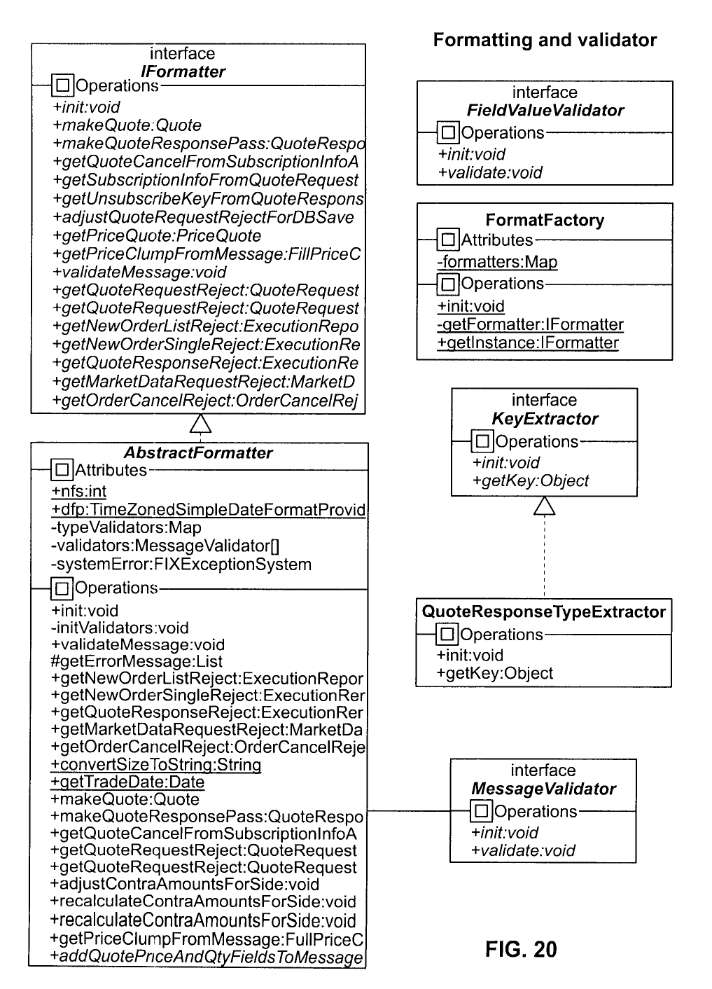

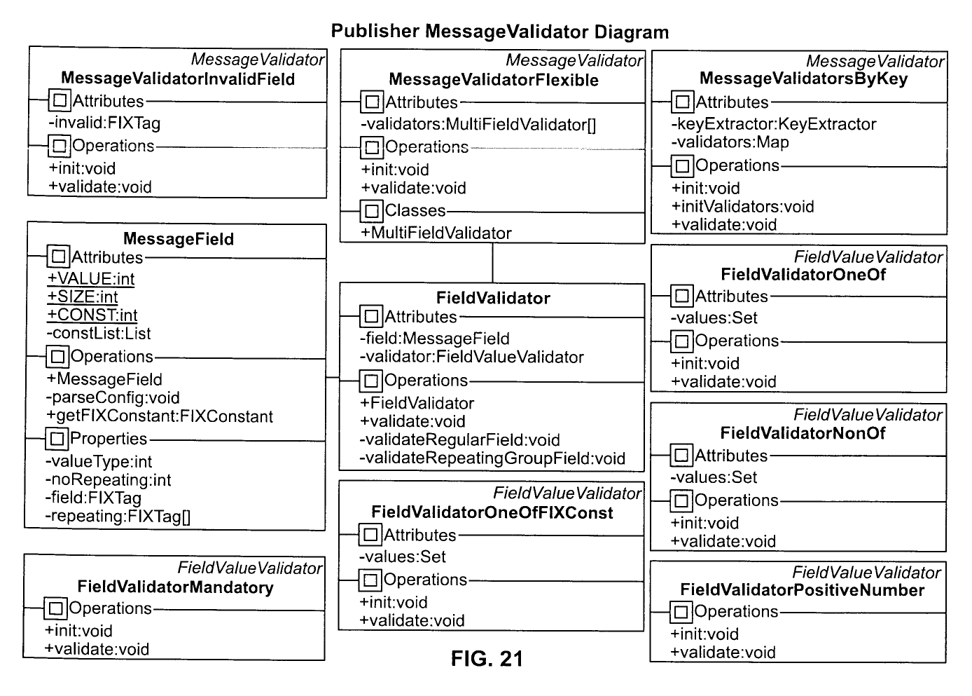

FIG. 20 depicts an exemplary Formatting and Validator diagram.

FIG. 21 depicts an exemplary Publisher MessageValidator diagram.

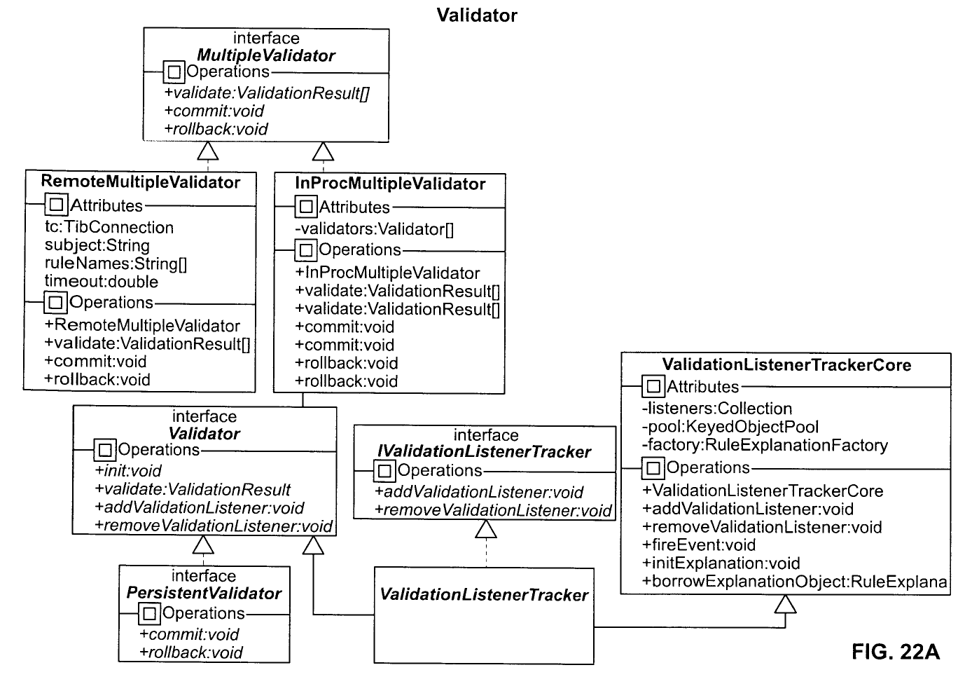

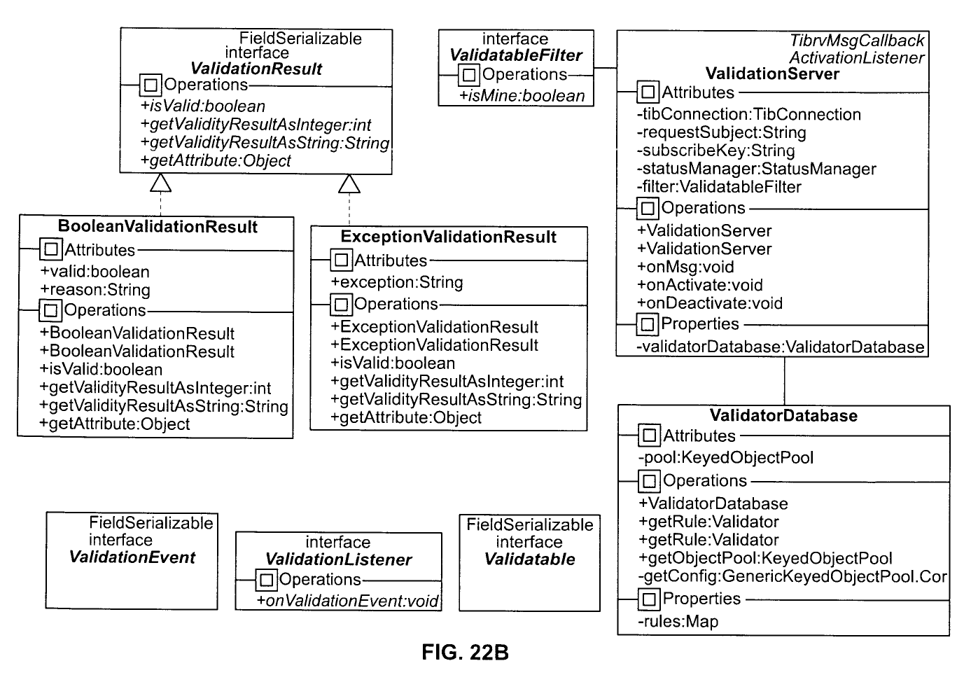

FIG. 22 depicts an exemplary Validator diagram.

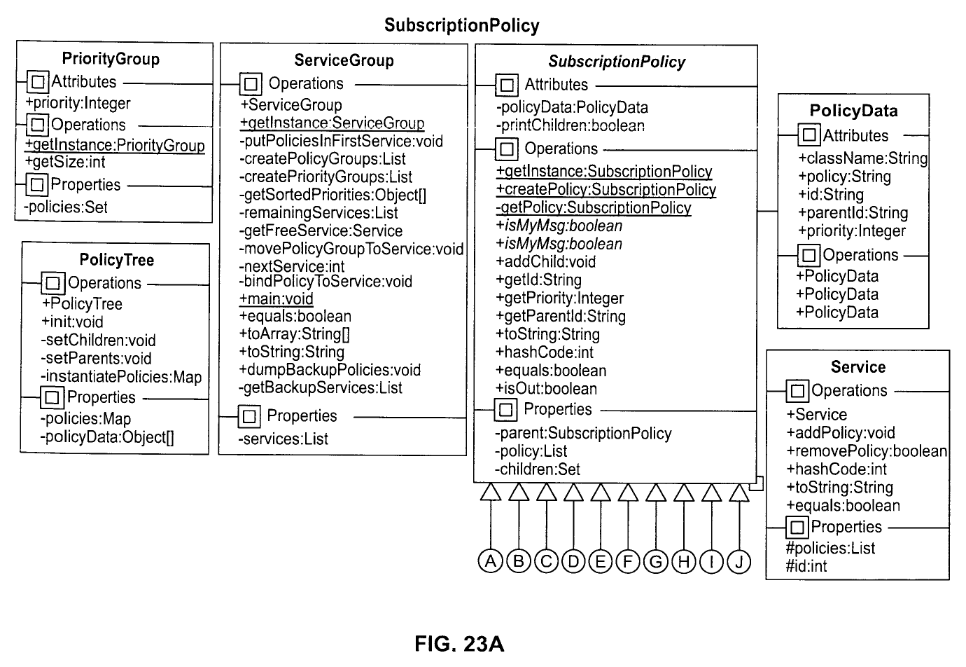

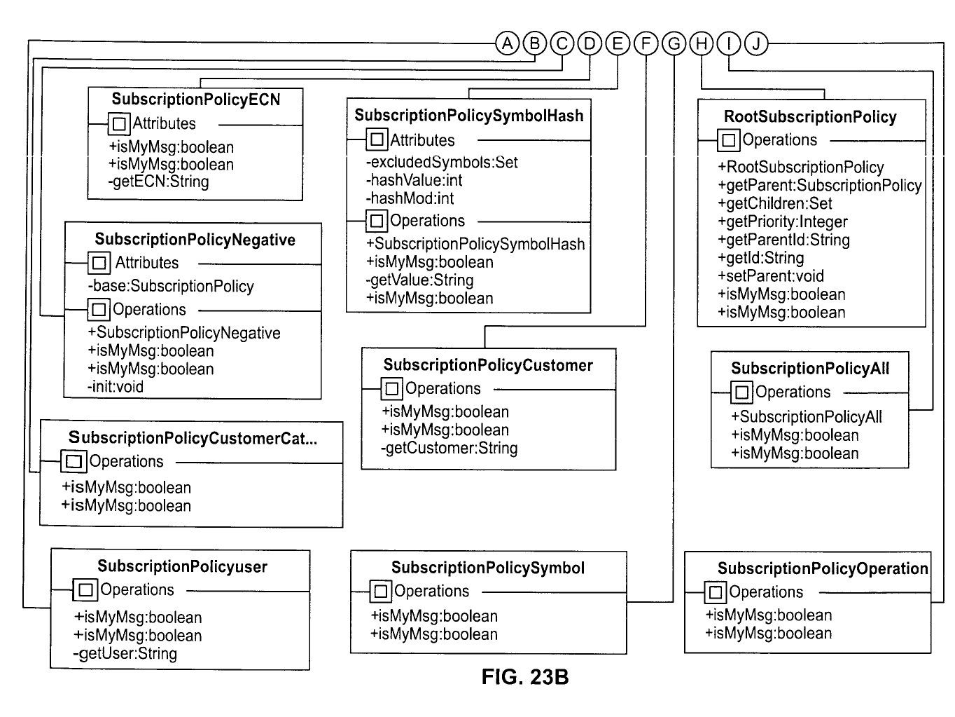

FIG. 23 depicts an exemplary SubscriptionPolicy diagram.

Other components and combinations of components may also be used to support processing data or other calculations described herein as will be evident to those skilled in the art. Server 330 may facilitate communication of data from a storage device 340 to and from processor 350, and communications to computers 300. Processor 350 may optionally include local or networked storage (not shown) which may be used to store temporary information. Software 360 can be installed locally at a computer 300, processor 350 and/or centrally supported for facilitating calculations and applications.

For ease of exposition, not every step or element of the present invention is described herein as part of a computer system and/or software, but those skilled in the art will recognize that each step or element may have (and typically will have) a corresponding computer system or software component. Such computer system and/or software components are therefore enabled by describing their corresponding steps or elements (that is, their functionality), and are within the scope of the present invention.

Moreover, where a computer system is described or claimed as having a processor for performing a particular function, it will be understood by those skilled in the art that such usage should not be interpreted to exclude systems where a single processor, for example, performs some or all of the tasks delegated to the various processors. That is, any combination of, or all of, the processors specified in the claims could be the same processor. All such combinations are within the scope of the invention.

The present invention has been described by way of example only, and the invention is not limited by the specific embodiments described herein. As still be recognized by those skilled in the art, improvements and modifications may be made to the invention and the illustrative embodiments described herein without departing from the scope or spirit of the invention.

What is claimed is:

1. A computer-implemented method comprising:
electronically receiving a price request;
processing in a pipeline price information corresponding to said price request by applying a sequence of configurable rules to said price information;
temporarily withdrawing said price information from said pipeline while at least one of said configurable rules being applied is waiting for additional information;
inserting said price information into said pipeline after said additional information is received by said at least one of said configurable rules;
calculating a price based on said processed price information; and
electronically transmitting said price in response to said price request.

2. A method as in claim 1, wherein said sequence of configurable rules is applied only upon occurrence of specified events.

3. A method as in claim 1, wherein said sequence of configurable rules is applied based on recent market data.

4. A method as in claim 1, wherein said sequence of configurable rules is applied in the same linear order each time a price request is received.

5. A method as in claim 1, wherein said price information is temporarily withdrawn from the pipeline by a price interruption block.

6. A method as in claim 5, wherein said price interruption block is a rule block that causes rules to be evaluated in a sequence.

7. A method as in claim 5, wherein said price interruption block is a rule block that asks each rule being applied if the rule is waiting for additional information from an external source.

8. A method as in claim 5, wherein said at least one of said configurable rules waiting for additional information sends an event to the price interruption block when the at least one rule receives said additional information.

9. A method as in claim 1, wherein said price request is for a currency price.

10. A method as in claim 1, wherein said price request is for a security price.

11. A method as in claim 1, wherein said price request is for a swap price.

12. A method as in claim 1, wherein said price request is for a derivative price.

13. Software stored on a computer readable medium and implemented on a computer system comprising:
software operable to instruct said computer system to electronically receive a price request;
software operable to instruct said computer system to process in a pipeline price information corresponding to said price request by applying a sequence of configurable rules to said price information;
software operable to instruct said computer system to temporarily withdraw said price information from said pipeline while at least one of said configurable rules being applied is waiting for additional information;
software operable to instruct said computer system to insert said price information into said pipeline after said additional information is received by said at least one of said configurable rules;
software operable to instruct said computer system to calculate a price based on said processed price information; and
software operable to instruct said computer system to electronically transmit said price in response to said price request.

14. Software as in claim 13, wherein said sequence of configurable rules is applied only upon occurrence of specified events.

15. Software as in claim 13, wherein said sequence of configurable rules is applied based on recent market data.

16. Software as in claim 13, wherein said sequence of configurable rules is applied in the same linear order each time a price request is received.

17. A method as in claim 13, wherein said price information is temporarily withdrawn from the pipeline by a price interruption block.

18. Software as in claim 17, wherein said price interruption block is a rule block that causes rules to be evaluated in a sequence.

19. Software as in claim 17, wherein said price interruption block is a rule block that asks each rule being applied if the rule is waiting for additional information from an external source.

20. Software as in claim 17, wherein said at least one of said configurable rules waiting for additional information sends an event to the price interruption block when the at least one rule receives said additional information.

21. Software as in claim 13, wherein said price request is for a currency price.

22. Software as in claim 13, wherein said price request is for a security price.

23. Software as in claim 13, wherein said price request is for a swap price.

24. Software as in claim 13, wherein said price request is for a derivative price.

25. A computer system comprising:
a server component operable to electronically receive a price request:
a pricing component in communication with said server component and operable to process in a pipeline price information corresponding to said price request by applying a sequence of configurable rules to said price information:
said pricing component further operable to temporarily withdraw said price information from said pipeline while at least one of said configurable rules being applied is waiting for additional information, to insert said price information into said pipeline after said additional information is received by said at least one of said configurable rules, and to calculate a price based on said processed price information; and
said server component further operable to electronically transmit said price in response to said price request.

26. A system as in claim 25, wherein said sequence of configurable rules is applied only upon occurrence of specified events.

27. A system as in claim 25, wherein said sequence of configurable rules is applied based on recent market data.

28. A system as in claim 25, wherein said sequence of configurable rules is applied in the same linear order each time a price request is received.

29. A system as in claim 25, wherein said price information is temporarily withdrawn from the pipeline by a price interruption block.

30. A system as in claim 29, wherein said price interruption block is a rule block that causes rules to be evaluated in a sequence.

31. A system as in claim 29, wherein said price interruption block is a rule block that asks each rule being applied if the rule is waiting for additional information from an external source.

32. A system as in claim 29, wherein said at least one of said configurable rules waiting for additional information sends an event to the price interruption block when the at least one rule receives said additional information.

33. A system as in claim 25, wherein said price request is for a currency price.

34. A system as in claim 25, wherein said price request is for a security price.

35. A system as in claim 25, wherein said price request is for a swap price.

36. A system as in claim 25, wherein said price request is for a derivative price.

37. A computer-implemented method comprising:
electronically receiving a request for data;
processing in a pipeline information corresponding to said data request by applying a sequence of configurable rules to said information;
temporarily withdrawing said information from said pipeline while at least one of said configurable rules being applied is waiting for additional information;
inserting said information into said pipeline after said additional information is received by said at least one of said configurable rules;
deriving said data based on said processed information; and
electronically transmitting said derived data in response to said data request.
